(19) United States
(12) Patent Application Publication
(10) Pub. No.: US 2010/0132797 A1
(43) Pub. Date: Jun. 3, 2010

(54) MICROFLUIDIC SYSTEM BASED ON ACTUATOR ELEMENTS

(75) Inventors: Menno Willem Jose Prins, Eindhoven (NL); Johannes Wilhelmus Weekamp, Eindhoven (NL); Jacob Marinus Jan Den Toonder, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/530,792

(22) PCT Filed: Mar. 12, 2008
(86) PCT No.: PCT/IB08/50895

§ 371 Date: Sep. 11, 2009

(30) Foreign Application Priority Data
Mar. 12, 2007 (EP) 07103914.3

(51) Int. Cl. F15C 3/08; H01H 47/00; B01L 3/00; G05D 7/06; F15C 5/00; F15C 7/00

(52) U.S. Cl. 137/1; 361/139; 137/827; 137/829; 137/831; 29/890.09; 29/428

(57) ABSTRACT

The present invention provides a microfluidic system comprising at least one microchannel (18) having an inner wall (17). The microfluidic system comprises attached to the inner wall (17) of the at least one microchannel (18) a plurality of ciliary N actuator elements (10a-d) and at least one floating current wire (14a-d) present in the at least one microchannel (18) for applying a magnetic field to the plurality of ciliary actuator elements (10a-d) for changing their shape and/or orientation. The present invention also provides a method for the manufacturing of such microfluidic systems and to a method for controlling a fluid flow through a microchannel (18) of such a microfluidic system.

### FIELD OF THE INVENTION

The present invention relates to microfluidic systems, to a method for the manufacturing of such microfluidic systems and/or to a method for controlling or manipulating a fluid flow through a microchannel of such microfluidic systems, as well as to a controller for controlling a fluid flow through a microchannel of a microfluidic system, and software for use with a microfluidic system in a method for controlling. The microfluidic systems may be used, for example, in biotechnological and pharmaceutical applications and in microchannel cooling systems in microelectronics applications. Microfluidic systems according to embodiments of the present invention can be compact, cheap and easy to process.

### BACKGROUND OF THE INVENTION

Microfluidics relates to a multidisciplinary field comprising physics, chemistry, engineering and biotechnology that studies the behavior of fluids at volumes thousands of times smaller than a common droplet. Microfluidic components form the basis of so-called “lab-on-a-chip” devices or biochip networks that can process microliter and nanoliter volumes of fluid and conduct highly sensitive analytical measurements. The fabrication techniques used to construct microfluidic devices are relatively inexpensive and are amenable both to highly elaborate, multiplexed devices and also to mass production. In a manner similar to that for microelectronics, microfluidic technologies enable the fabrication of highly integrated devices for performing several different functions on a same substrate chip.

Microfluidic chips are becoming a key foundation to many of today's fast-growing biotechnologies, such as rapid DNA separation and sizing, cell manipulation, cell sorting and molecule detection. Microfluidic chip-based technologies offer many advantages over their traditional macrosized counterparts. Microfluidics is a critical component in, amongst others, gene chip and protein chip development efforts.

In all microfluidic devices, there is a basic need for controlling the fluid flow, that is, fluids must be transported, mixed, separated and directed through a microchannel system consisting of channels with a typical width of about 0.1 mm. A challenge in microfluidic actuation is to design a compact and reliable microfluidic system for regulating or manipulating the flow of complex fluids of variable composition, e.g. saliva and full blood, in microchannels. Various actuation mechanisms have been developed and are at present used, such as, for example, pressure-driven schemes, microfabricated mechanical valves and pumps, inkjet-type pumps, electro-kinetically controlled flows, and surface-acoustic waves.

The application of microelectromechanical systems (MEMS) technology to microfluidic devices has spurred the development of micro-pumps to transport a variety of liquids at a large range of flow rates and pressures.

In patent application EP 05101291.2 (not published yet) a microfluidic system is proposed based on actuator elements attached at one end to a microchannel wall. The actuator elements can be set in motion by changing their shape by applying an external stimulus. According to one embodiment, the external stimulus is a magnetic field. The channel wall of the microfluidic system is thus covered with the actuator elements and their concerted change in shape, e.g. from a curled shape into a straight shape, sets a fluid which is present in the channel in motion. The covering of the walls may, for example, be done in a two-D array fashion. By individually addressing the actuator elements or by addressing rows of actuator elements, a wave-like movement, an otherwise correlated movement, or an uncorrelated movement may be generated that can be advantageous in transporting, mixing or creating vortices.

FIG. 1 illustrates a basic principle of an actuator element 30, in the example given a flap, which is attached to the inner wall 35 of a channel 36 and which is magnetically actuated. One way to enable magnetic actuation of the actuator element 30 is by incorporating superparamagnetic particles in the actuator element 30. In the example given in FIG. 1, a spatially varying magnetic field is applied by a current wire 41 located in the wall 35 of the channel 36. Because of the location of the current wire 41, i.e. underneath the actuator element 30, the actuator element 30 experiences a magnetic field gradient. The magnetic field will be larger close to the wall 35 of the channel 36 than further away from the wall 35. For example, in FIG. 1, at location A, the magnetic field will be larger than at location B, and at location B the magnetic field will be larger than at location C. The magnetic force acts in the direction of the gradient, i.e. towards the current wire 41.

The application of an external magnetic field \vec{H} will result in translational forces on the actuator elements 30. The translational force equals:

\vec{F}=∇(\vec{m}·\vec{B}) (1)

wherein \vec{m} is the magnetic moment of the flap 30 and \vec{B} the magnetic induction. To obtain actuator elements 30 suitable for use in a microfluidic device, the resulting force acting on the actuator element 30, on one hand, must be sufficient to significantly bend the actuator element 30, i.e. to overcome the stiffness of the actuator element 30 and on the other hand must be large enough to exceed the drag acting upon the actuator element 30 by the surrounding fluid present in the channel 36. To achieve this, the magnetic field gradient at the position of the actuator element 30 must be sufficiently large, especially at the tip of the actuator element 30 where the magnetic force is most effective in causing bending.

Location of a current wire 41 integrated in the wall 35 of the channel 36 of the microfluidic system, as illustrated in FIG. 1, may not be most effective because the magnetic field gradient falls off rapidly as 1/r² and the force acting on the actuator element 30 falls off as 1/r³, wherein r is the distance between a location (e.g. A, B, C) on the actuator element and the current wire 41. Therefore, quite large currents, which may in some cases, depending on the application, be higher than 10 A, are to be sent through the current wire 41 in order to actuate or get sufficient bending of the actuator element 30 to be suitable for use in microfluidic systems as described above.

### SUMMARY OF THE INVENTION

It is an object of the present invention to provide a good microfluidic system and/or a method of manufacturing and/or operating the same.

Advantages of the microfluidic system according to embodiments of the present invention can be at least one of being compact, cheap and easy to process. The microfluidic systems according to embodiments of the present invention may be economical and simple to process, while also being robust and compact and suitable for use with complex biological fluids such as e.g. saliva, sputum or full blood.

The microfluidic systems according to embodiments of the present invention may provide enhanced actuation effects at equal or lower electrical currents with respect to prior art microfluidic systems in which magnetic actuation is obtained by a magnetic field generated by a current wire located in the wall of the microchannel.

In view of the enhanced actuation effects, the microfluidic systems according to embodiments of the present invention may show good, preferably improved, effectiveness of flow generation. Furthermore, in view of the lower electrical currents which may be used for obtaining same actuation effects, microfluidic systems according to embodiments of the present invention may have a low power consumption.

The above objective is accomplished by a method and device according to the present invention.

Particular and preferred aspects of the invention are set out in the accompanying independent and dependent claims. Features from the dependent claims may be combined with features of the independent claims and with features of other dependent claims as appropriate and not merely as explicitly set out in the claims.

In a first aspect, the present invention provides a microfluidic system comprising at least one microchannel having an inner wall, the microfluidic system furthermore comprising:

a plurality of ciliary actuator elements attached to the inner wall, each ciliary actuator element having a shape and an orientation, and

magnetic field generator for applying a magnetic field to the plurality of ciliary actuator elements so as to cause a change in their shape and/or orientation, wherein the magnetic field generator for applying the magnetic field to the plurality of ciliary actuator elements is formed by at least one floating current wire present in the at least one microchannel.

Because of the use of magnetic actuation, the microfluidic system according to embodiments of the invention may work with very complex biological fluids such as e.g. saliva, sputum or full blood.

A further advantage of the microfluidic system according to embodiments of the present invention is that it provides enhanced actuation effects at equal or lower electrical currents with respect to prior art microfluidic systems in which magnetic actuation is obtained by a magnetic field generated by a current wire located in the wall of the microchannel.

The microfluidic system according to embodiments of the present invention may be used in biotechnological or biomedical applications such as biosensors, rapid DNA separation and sizing, cell manipulation and sorting, or in pharmaceutical applications, in particular high-throughput combinatorial testing where local mixing is essential. The microfluidic system according to embodiments of the present invention may also be used in microchannel cooling systems in microelectronics applications.

According to embodiments of the invention, a floating current wire may be provided for each of the plurality of ciliary actuator elements. In this way, each of the plurality of ciliary actuator elements can individually be addressed. Alternatively, a floating current wire may be provided for a subset of the plurality of ciliary actuator elements, in which case the ciliary actuator elements in the subset may be actuated together, while different subsets of ciliary actuator elements may be actuated separately.

The at least one floating current wire may be attached to the at least one microchannel at one end.

According to embodiments of the invention, the inner wall of the at least one microchannel may lye in a plane and the plurality of ciliary actuator elements may be oriented substantially perpendicular to the plane of the inner wall of the at least one microchannel. A floating current wire may be located in between each two subsequent ciliary actuator elements.

The plurality of ciliary actuator elements may have a length L and the at least one floating current wire may be located at a distance L_{w} between 0 and 2L, preferably between L/2 and 2L, more preferably between L/2 and 1.5L and most preferably between L and 1.5L, from the inner wall of the at least one microchannel.

The inner wall of the at least one microchannel may lye in a plane, and the plurality of ciliary actuator elements may be oriented substantially parallel to the plane of the inner wall of the at least one microchannel. The at least one floating current wire may be located above at least part of the ciliary actuator elements. The at least one floating current wire may show an overlap with at least part of the ciliary actuator elements, the overlap being defined by projection of the at least one floating current wire onto the plurality ciliary actuator element according to a direction substantially perpendicular to the plane of the inner wall of the at least one microchannel. A distance L_{w} between the plurality of ciliary actuator elements and the at least one floating current wire may be between 1 μm and 1000 μm, preferably between 1 μm and 100 μm, most preferably between 10 μm and 100 μm.

According to preferred embodiments of the invention, the plurality of ciliary actuator elements may be polymer actuator elements because

the actuator elements should be compliant, i.e. not stiff,

the actuator elements should be tough, not brittle, and

the actuator elements should be easy to process by means of relatively cheap processes.

The polymer actuator elements may comprise polymer MEMS.

According to embodiments of the invention, the plurality of polymer actuator elements may comprise an Ionomeric Polymer-Metal Composite (IPMC).

The ciliary actuator elements may comprise one of a uniform continuous magnetic layer, a patterned continuous magnetic layer and magnetic particles.

The microfluidic system may furthermore comprise at least one magnetic sensor for measuring movement of the plurality of ciliary actuator elements.

In another aspect, the present invention also provides the use of the microfluidic system according to any of the previous claims in biotechnological, pharmaceutical, electrical or electronic applications.

In still a further aspect, the present invention provides a method for the manufacturing of a microfluidic system comprising at least one microchannel, the method comprising:

providing an inner wall of the at least one microchannel with a plurality of ciliary actuator elements, and

providing at least one floating current wire in the at least one microchannel for applying a stimulus to said plurality of ciliary actuator elements.

An advantage of a method according to embodiments of the present invention is that it provides a microfluidic system showing enhanced actuation effects at equal or lower electrical currents with respect to prior art microfluidic systems in which current wires are located in the wall of the microchannel. A further advantage is that it provides a microfluidic system with reduced power consumption compared to prior art microfluidic systems with current wires located in the wall of the microchannel.

Providing at least one floating current wire in the at least one microchannel may be performed by wire bonding at least one current wire to the inner wall of the at least one microchannel.

According to embodiments of the invention, the method may furthermore comprise providing the ciliary actuator elements with one of a uniform continuous magnetic layer, a patterned continuous magnetic layer, or with magnetic particles.

In yet a further aspect, the present invention provides a method for controlling a fluid flow through a microchannel of a microfluidic system, the microchannel having an inner wall, the inner wall of the microchannel having a plurality of ciliary actuator elements, the ciliary actuator elements each having a shape and an orientation. The method comprises providing a current through at least one floating current wire present in the microchannel for applying a magnetic field to the ciliary actuator elements so as to cause a change in the shape and/or orientation of at least one ciliary actuator element.

Because of the use of magnetic actuation, the method for controlling a fluid flow through a microchannel of a microfluidic system according to embodiments of the invention may be used with very complex biological fluids such as e.g. saliva, sputum or full blood.

Providing a current through at least one floating current wire may be performed by providing a current of between 0.1 A and 10 A, preferably between 0.1 A and 5 A, more preferably between 0.1 A and 1 A.

The present invention also provides a controller for use in a microfluidic system for controlling a fluid flow through a microchannel of a microfluidic system according to embodiments of the present invention.

According to embodiments of the present invention, a controller is provided for controlling a fluid flow through a microchannel of a microfluidic system. The microchannel has an inner wall, the inner wall of the microchannel having a plurality of ciliary actuator elements, the ciliary actuator elements each having a shape and an orientation. The controller according to embodiments of the present invention comprises a control unit for controlling the flowing of a current through at least one floating current wire present in the microchannel, so as to apply a controlled magnetic field to the ciliary actuator elements so as to cause a change in the shape and/or orientation of at least one ciliary actuator element.

The present invention furthermore provides a computer program product enabling a processor to carry out a method for controlling a fluid flow through a microchannel of a microfluidic system as described above. for the computer program product, when executed on a computing means, performs a method for controlling a fluid flow through a microchannel of a microfluidic system according to embodiments of the present invention, the method at least comprising providing a current through at least one floating current wire present in the microchannel for applying a magnetic field to ciliary actuator elements attached to an inner wall of the microchannel so as to cause a change in the shape and/or orientation of at least one ciliary actuator element.

The present invention furthermore relates to a machine readable data storage device storing the computer program product as describe above and/or the transmission of such a computer program product over a local or wide area telecommunications network. The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

### BRIEF DESCRIPTION OF THE DRAWINGS

FIG. 1 illustrates a superparamagnetic polymer flap actuated in a non-homogeneous magnetic field induced by a current wire according to the prior art.

FIG. 2 illustrates an example of a ciliary beat cycle showing the effective and recovery strokes.

FIG. 3 illustrates a wave of cilia showing their co-ordination in a metachronic wave.

FIG. 4 illustrates a polymer actuator element comprising a continuous magnetic layer according to an embodiment of the present invention.

FIG. 5 schematically illustrates a polymer actuator element comprising magnetic particles according to an embodiment of the present invention.

FIG. 6 schematically illustrates floating current wires obtained by wire bonding.

FIG. 7 illustrates a microfluidic system according to an embodiment of the present invention.

FIGS. 8 to 11 illustrate subsequent actuation of subsequent actuator elements in a system such as the microfluidic system of FIG. 7.

FIG. 12 illustrates a microfluidic system according to another embodiment of the present invention.

FIGS. 13 to 16 illustrate subsequent actuation of subsequent actuator elements in the microfluidic system of FIG. 12.

FIG. 17 illustrates a bending polymer actuator element and a responsive surface covered with such bending polymer actuator element according to an embodiment of the present invention.

FIG. 18 is a schematic illustration of a bending polymer actuator element according to an embodiment of the present invention.

FIG. 19 schematically illustrates a system controller for use with a microfluidic system according to embodiments of the present invention.

FIG. 20 is a schematic representation of a processing system as can be used for performing a method for controlling a fluid flow through a microchannel of a microfluidic system according to embodiments of the present invention.

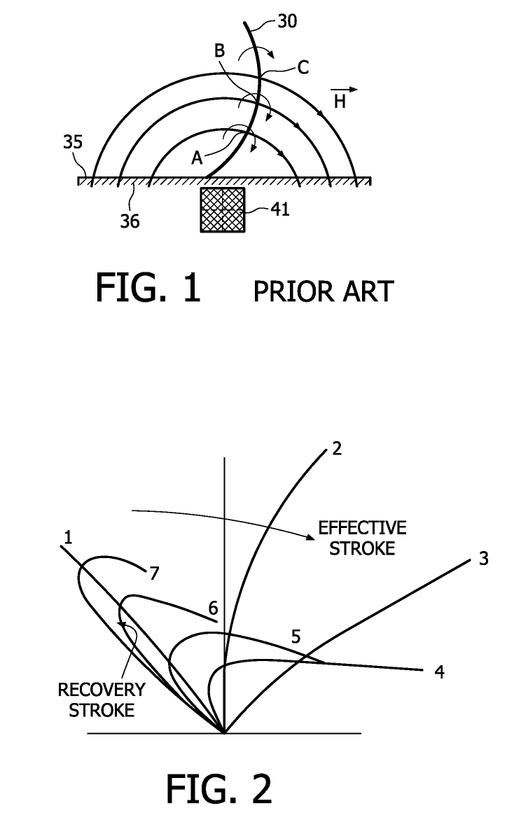

In the different figures, the same reference signs refer to the same or analogous elements.

### DETAILED DESCRIPTION OF EMBODIMENTS

The present invention will be described with respect to particular embodiments and with reference to certain drawings but the invention is not limited thereto but only by the claims. Any reference signs in the claims shall not be construed as limiting the scope. The drawings described are only schematic and are non-limiting. In the drawings, the size of some of the elements may be exaggerated and not drawn on scale for illustrative purposes.

Where the term “comprising” is used in the present description and claims, it does not exclude other elements or steps. Where an indefinite or definite article is used when referring to a singular noun e.g. “a” or “an”, “the”, this includes a plural of that noun unless something else is specifically stated.

Furthermore, the terms first, second, third and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated herein.

Moreover, the terms top, bottom, above, underneath and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

In a first aspect, the present invention provides a microfluidic system provided with magnetic actuators, e.g. magnetic actuation means which allow transportation or (local) mixing or directing of fluids through microchannels of a microfluidic system. In a second aspect, the present invention provides a method for the manufacturing of such a microfluidic system. In a third aspect, the present invention provides a method for controlling fluid flow through microchannels of the microfluidic system.

The microfluidic systems according to embodiments of the present invention are economical and simple to process, while also being robust and compact and suitable for complex fluids.

A microfluidic system according embodiments of the present invention comprises at least one microchannel having an inner wall. The microfluidic system furthermore comprises a plurality of ciliary actuator elements attached to the inner wall of the at least one microchannel, each ciliary actuator element having a shape and an orientation. Further means for applying stimuli, i.e. a magnetic field, to the plurality of ciliary actuator elements are provided so as to cause a change in the shape and/or orientation of the ciliary actuator elements. According to an embodiment of the present invention, the means for applying stimuli, i.e. a magnetic field, to the plurality of ciliary actuator elements is formed by at least one floating current wire present in the at least one microchannel.

The microfluidic system according to the invention may be used in biotechnological applications, such as micrototal analysis systems, bioreactors, microfluidic diagnostics, micro-factories and chemical or biochemical micro-plants, biosensors, rapid DNA separation and sizing, cell manipulation and sorting, in pharmaceutical applications, in particular high-throughput combinatorial testing where local mixing is essential, and in microchannel cooling systems e.g. in microelectronics applications.

In one aspect of the invention, the way in which the actuator elements are envisioned to work is inspired by nature. Nature knows various ways to manipulate fluids at small scales, i.e. 1-100 micron scales. One particular mechanism found is that due to a covering of beating cilia over the external surface of micro-organisms, such as, for example, paramecium, pleurobrachia, and opaline. Ciliary motile clearance is also used in the bronchia and nose of mammals to remove contaminants. A cilium can be seen as a small hair or flexible rod which in, for example, protozoa may have a typical length of 10 μm and a typical diameter of 0.1 μm, attached to a surface. Apart from a propulsion mechanism for micro-organisms, other functions of cilia are in cleansing of gills, feeding, excretion and reproduction. The human trachea, for example, is covered with cilia that transport mucus upwards and out of the lungs. Cilia are also used to produce feeding currents by sessile organisms that are attached to a rigid substrate by a long stalk. The combined action of the cilia movement with the periodic lengthening and shortening of the stalk induces a chaotic vortex. This results in chaotic filtration behavior of the surrounding fluid.

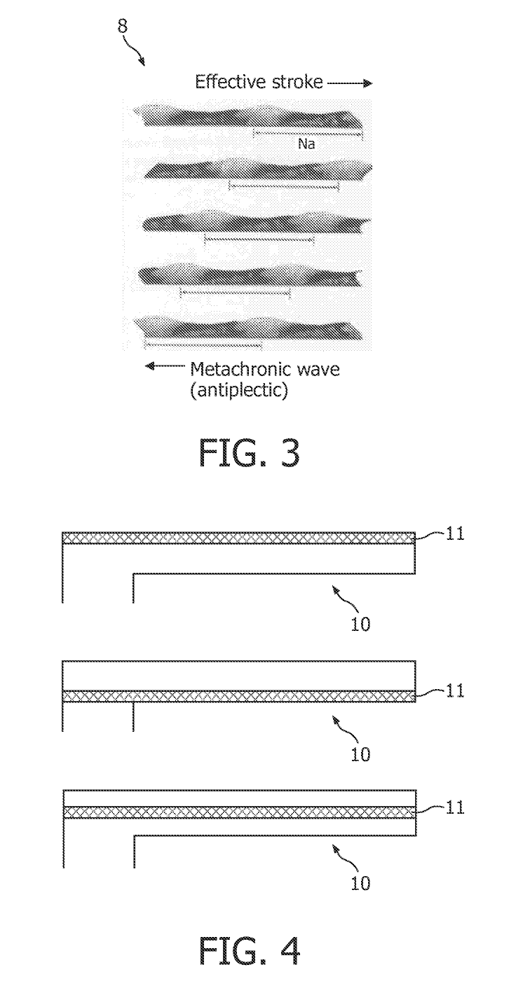

The above discussion illustrates that cilia can be used for transporting and/or mixing fluid in microchannels. The mechanics of ciliary motion and flow has interested both zoologists and fluid mechanists for many years. The beat of a single cilium can be separated into two distinct phases i.e. a fast effective stroke (curve 1 to 3 of FIG. 2) when the cilium drives fluid in a desired direction and a recovery stroke (curve 4 to 7 of FIG. 2) when the cilium seeks to minimize its influence on the generated fluid motion. In nature, fluid motion is caused by high concentrations of cilia in rows along and across the surface of an organism. The movements of adjacent cilia in one direction are out of phase, this phenomenon is called metachronism. Thus, the motion of cilia appears as a wave passing over the organism. FIG. 3 illustrates such a wave 8 of cilia showing their co-ordination in a metachronic wave. A model that describes the movement of fluid by cilia is published by J. Blake in ‘A model for the micro-structure in ciliated organisms’, J. Fluid. Mech. 55, p. 1-23 (1972). In this article, it is described that the influence of cilia on fluid flow is modeled by representing the cilia as a collection of “Stokeslets” along their centerline, which can be viewed as point forces within the fluid. The movement of these Stokeslets in time is prescribed, and the resulting fluid flow can be calculated. Not only the flow due to a single cilium can be calculated, also that due to a collection of cilia covering a single wall with an infinite fluid layer on top, moving according to a metachronic wave.

The approach in a preferred aspect of the present invention makes use of this principle to mimic the cilia-like fluid manipulation in microchannels by covering the walls of the microchannels with “artificial cilia” based on microscopic actuator elements, i.e. structures changing their shape and/or dimension in response to an applied magnetic field. Hence, one aspect of the present invention provides a microfluidic system or microfluidic flow device such as a pump having means for artificial ciliary metachronic activity.

According to the invention, all suitable materials, i.e. materials that are able to change their shape by, for example, mechanically deforming as a response to an applied magnetic field may be used for forming the artificial ciliary or ciliary actuator elements.

According to most preferred embodiments of the invention, the actuator elements may be based on polymer materials. Suitable materials may be found in the book “Electroactive Polymer (EAP) Actuators as Artificial Muscles”, ed. Bar-Cohen, SPIE Press, 2004. However, also other materials may be used for the actuator elements. The materials that may be used to form actuator elements according to the present invention should be such that the formed actuator elements have the following characteristics:

the actuator element should be compliant, i.e. not stiff,

the actuator element should be tough, not brittle,

the actuator elements should respond to a magnetic field by bending or changing shape, and

the actuator elements should be easy to process by means of relatively cheap processes.

The material that is used to form the actuator elements may have to be functionalized. Considering the first, second and fourth characteristic of the above summarized list, polymers are preferred for at least a part of the actuators. Most types of polymers can be used according to the present invention, except for very brittle polymers such as e.g. polystyrene which are not very suitable for use with the present invention.

Because of the above, according to the present invention, the actuator elements may preferably be formed of, or include as a part of their construction, polymer materials. Therefore, in the further description, the invention will be described by means of polymer actuator elements. It has, however, to be understood by a person skilled in the art that the present invention may also be applied when other materials than polymers, as described above, are used to form the actuator elements. Polymer materials are, generally, tough instead of brittle, relatively cheap, elastic up to large strains (up to 10%) and offer perspective of being processable on large surface areas with simple processes.

According to embodiments of the present invention, to obtain magnetic actuation, metals may be also used to form at least part of the actuator elements, e.g. in Ionomeric Polymer-Metal composites (IPMC). For example, FeNi or another magnetic material may be used to form the actuator elements. A disadvantage of metals, however, could be mechanical fatigue and cost of processing.

According to other embodiments, to be able to actuate the actuator elements by applying a magnetic field, the actuator elements must be provided with magnetic properties.

One way to provide a polymer actuator element 10 with magnetic properties is by incorporating a continuous magnetic layer 11 in the polymer actuator element 10, as shown in the different embodiments represented in FIG. 4. The actuator elements 10 with magnetic properties will in the further description be referred to as magnetic actuator elements 10 or polymer actuator elements 10. The continuous magnetic layer 11 may be positioned at the top (upper drawing of FIG. 4) or at the bottom of the actuator element 10 (drawing in the middle of FIG. 4), or may be situated in the centre of the actuator element 10 (lower drawing of FIG. 4). The position of the continuous magnetic layer 11, together with its thermo-mechanical properties, determine the “natural”, initial or non-actuated shape of the magnetic actuator element 10, i.e. flat, curled upward or curled downward. The continuous magnetic layer 11 may, for example, be an electroplated Permalloy (e.g. Ni—Fe) and may, for example, be deposited as a uniform layer. The continuous magnetic layer 11 may have a thickness of between 0.1 and 10 μm. The direction of easy magnetization may be determined by the deposition process and may, in the example given, be the ‘in-plane’ direction. Instead of a uniform layer, the continuous magnetic layer 11 may also be patterned (not shown in the drawings) to increase the compliance and ease of deformation of the magnetic actuator elements 10.

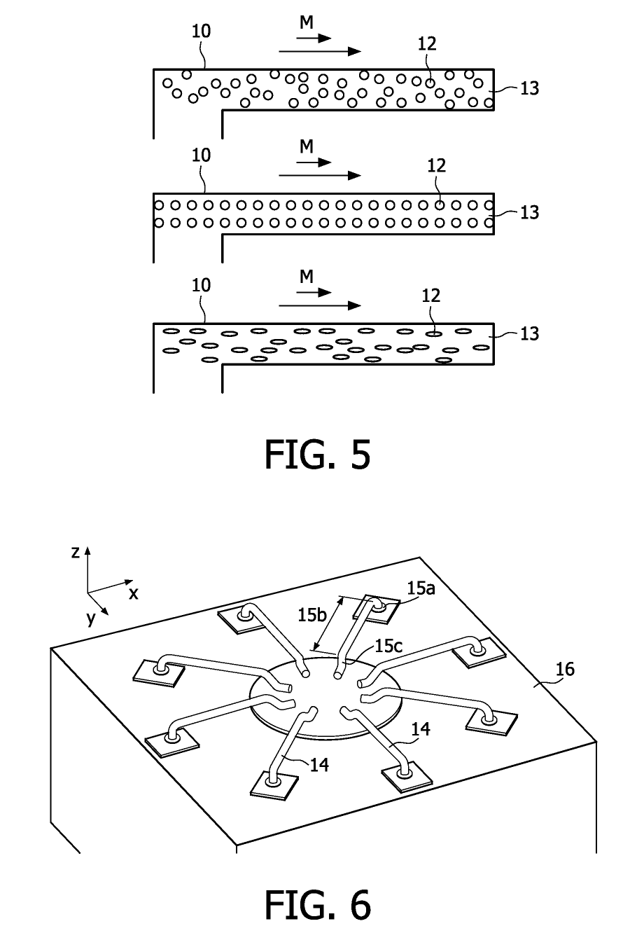

Another way to provide a polymer actuator element 10 with magnetic properties is incorporation of magnetic particles 12 in the polymer actuator element 10. The polymer may in that case function as a ‘matrix’ in which magnetic particles 12 are dispersed, as is illustrated in FIG. 5, and will further be referred to as polymer matrix 13. The magnetic particles 12 may be added to the polymer in solution or may be added to monomers that, later on, then can be polymerized. In a subsequent step, the polymer may then be applied to the inner wall of the microchannel of the microfluidic system by any suitable method, e.g. by a wet deposition technique such as e.g. spin-coating. The magnetic particles 12 may for example be spherical, as illustrated in the upper two drawings in FIG. 5 or may be elongate, e.g. rod-shaped, as illustrated in the lower drawing in FIG. 5. The rod-shaped magnetic particles 12 may have the advantage that they may automatically be aligned by shear flow during the deposition process. The magnetic particles 12 may be randomly arranged in the polymer matrix 13, as illustrated in the upper and lower drawing of FIG. 5, or they may be arranged or aligned in the polymer matrix 13 in a regular pattern, e.g. in rows, as is illustrated in the drawing in the middle of FIG. 5.

The magnetic particles 12 may, for example, be ferro- or ferri-magnetic particles, or (super)paramagnetic particles, comprising, for example, elements such as cobalt, nickel, iron, ferrites. According to embodiments of the invention, the magnetic particles 12 may be superparamagnetic particles, i.e. they do not have a remanent magnetic field when an applied magnetic field has been switched off, especially when elastic recovery of the polymer is slow compared to magnetic field modulation. Long off-times of the magnetic field may save power consumption.

During deposition, a magnetic field may be used to move and align the magnetic particles 12, such that the net magnetization is directed in the length-direction of the magnetic actuator element 10.

In the following description, the actuator elements 12 such as polymer actuator elements may also be referred to as actuators, e.g. polymer actuators or micropolymer actuators, actuator elements, micropolymer actuator elements or polymer actuator elements. It has to be noticed that when any of these terms is used in the further description always the same microscopic actuator elements according to the invention are meant.

According to the present invention, the polymer actuator elements 10 can be actuated by applying a magnetic field. The magnetic field may be generated by sending a current through of at east one floating current wire present in at least one microchannel of a microfluidic system. Using floating current wires enables to bring the current wire closer to the tip of polymer actuator element 10, hereby increasing the effective force acting on the polymer actuator element 10 with respect to prior art microfluidic systems where current wires are integrated in a wall of a microchannel of the system, when assuming that a similar current is sent through the floating current wires in the microfluidic system according to embodiments of the present invention as through the integrated current wires of the microfluidic system according to the prior art.

According to preferred embodiments of the present invention, the floating current wires may be formed by wire bonding. FIG. 6 illustrates the principle of using wire bonding. The floating current wires 14 have a first part forming a first end 15a of the floating current wire 14, a second part 15b and a third part forming a second end 15c of the floating current wire 14. The first part or first end 15a of the floating current wire 14 may be attached to a substrate 16. When the substrate 16 is lying in a plane, this first part 15a may be oriented in a direction substantially perpendicular to the plane of the substrate 16, or in the z-direction as indicated in the co-ordinate system in FIG. 6. Alternatively, the first part 15a may be oriented in a direction substantially parallel to the plane of the substrate 16. The second part 15b of the floating current wire 14 may be oriented in a direction substantially parallel to the plane of the substrate 16, at a particular first distance from the substrate 16. The third part of second end 15c of the floating current wire 14 may also be oriented substantially parallel to the plane of the substrate 16 but, for example, at a second distance being different from the first distance. It has to be understood that the floating current wires 14 may also have other shapes and that the above description is only for the ease of explanation and is not intended to limit the invention in any way.

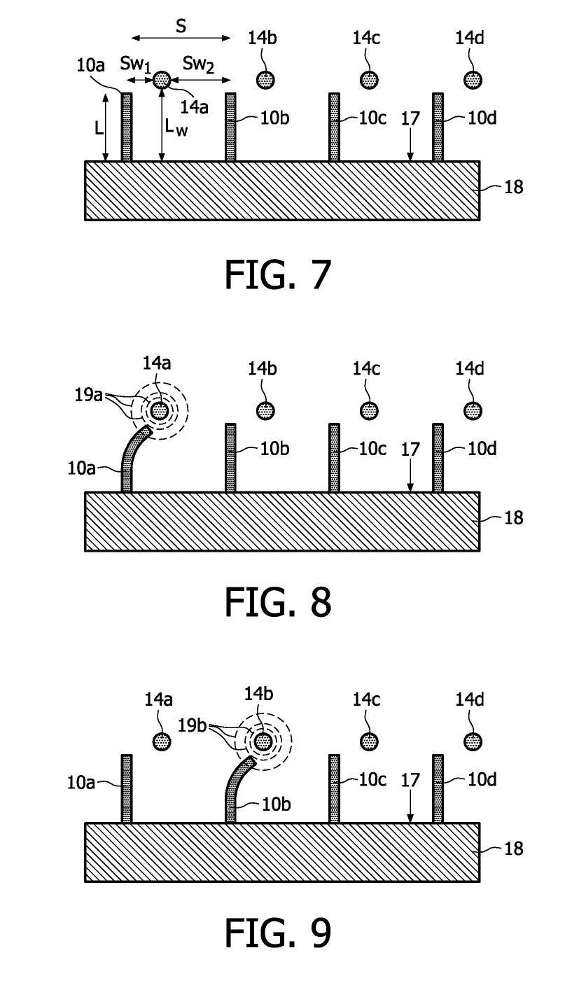

According to embodiments of the present invention, the at least one floating current wire 14 may be attached to the microchannel with one of its ends 15a, similar to the floating current wires 14 as illustrated in FIG. 6. Integrating and positioning of the floating current wires 14 in the microchannels of the microfluidic system may be done in various ways. FIG. 7 illustrates an embodiment according to the present invention. In this example, polymer actuator elements 10a-d are attached to an inner wall 17 of a microchannel 18 of a microfluidic system. According to the embodiment illustrated in FIG. 7, when the inner wall 17 of the microchannel 18 is lying in a plane, the polymer actuator elements 10a-d may be straight flaps positioned substantially perpendicular to the plane of the inner wall 17 of the microchannel 18. According to most preferred embodiments of the invention and as illustrated in the example given in FIG. 7, a separate floating current wire 14a-d may be provided for each of the polymer actuator elements 10a-d. The floating current wires 14a-d may be located slightly above the polymer actuator elements 10a-d (with respect to the inner wall 17) and slightly aside of it (seen on a perpendicular projection of the polymer actuator elements 10a-d and the floating current wire 14a-d on the inner wall 17). This way, a floating current wire 14a-d may be present in between subsequent polymer actuator elements 10a-d, optionally at a level farther away from the inner wall 17 than the top of the polymer actuator elements 10a-d. According to preferred embodiments, when a floating current wire 14a is located in between a first polymer actuator element 10a and a second polymer actuator element 10b (see FIG. 7), the distance between the first and second polymer actuator element 10a, 10b being indicated by S, a first floating current wire 14a may be located at a first distance S_{w1} from the first polymer actuator element 10a and at a second distance S_{w2} from the second polymer actuator element 10b. Most preferably, the first distance S_{w1} may be different from the second distance S_{w2}. For example and as illustrated in FIG. 7, the first distance S_{w1} may be smaller than the second distance S_{w2}. In this case, the positioning of the floating current wires 14 is asymmetric with respect to the positioning of the actuator elements 10a-d so that one single polymer actuator element 10a-d may be mainly addressed by a single floating current wire 14a-d. In the example given in FIG. 7, S_{w1} is smaller than S_{w2} and thus the polymer actuator elements 10a-d will be actuated by the floating current wire 14a-d positioned closest to that polymer actuator element 10a-d, in the example given the floating current wire 14a-d at their right side. However, according to other embodiments of the invention, S_{w2}may be smaller than S_{w1}. In that case, the polymer actuator elements 10a-d will be actuated by the floating current wire 14a-d positioned at their left side. According to still other but less preferred embodiments, S_{w1} may be equal to S_{w2}. In this case, the floating current wires 14a-d are positioned in the middle in between two subsequent polymer actuator elements 10a-d. For example, when current wire 14a is located in the middle between polymer actuator elements 10a and 10b and a current is sent through the current wire 14a, both polymer actuator elements 10a and 10b will be actuated at a same time. However, in this case, the force acting on the polymer actuator elements 10a, 10b will be smaller than in case only a single current wire 10a-d is used for actuating a single polymer actuator element 10a because the distance between the current wires 14a-d and the polymer actuator elements 10a-d is higher. In this case, higher currents have to be sent through the current wires 14a-d in order to obtain a same magnitude of the generated magnetic field at the position of the polymer actuator elements 10a-d with respect to the other two cases described above.

Furthermore, the floating current wires 14a-d may be located at a distance L_{w} from the inner wall 17 of the microchannel 18 of the microfluidic system. This distance L_{w} from the inner wall 17 may be tuned depending on the application of the microfluidic system. When the polymer actuator elements 10a-d have a length L, the distance L_{w} between the inner wall 17 of the microchannel 18 and the current wires 14a-d may, as illustrated in FIG. 7, be higher than the length L of the polymer actuator elements 10a-d. However, according to other embodiments, the floating current wires 14a-d may also be located at a distance L_{w}=L/2 or in other words the floating current wires 14a-d may be located halfway the polymer actuator elements 10a-d. According to still other, though less preferred, embodiments, the floating current wires 14a-d may be located at a distance L_{w} lower than L/2. In embodiments of the present invention, L_{W} may be between 0 and 2L.

Preferably, the polymer actuator elements 10a-d may have a length L between 10 and 200 μm and may typically be 100 μm, and may have a width of between 2 and 30 μm, typically 20 μm. The polymer actuator elements 10a-d may have a thickness of between 0.1 and 2 μm, typically 1 μm. The floating current wires 14a-d may preferably have a length of between 100 μm and 10 mm, preferably between 100 μm and 1 mm and may have a diameter of between 10 μm and 100 μm, for example 25 μm. The floating current wires 14a-d may be located at a distance L_{w} between 0 and 2L, preferably between L/2 and 2L, more preferably between L/2 and 1.5L and most preferably between L and 1.5L, from the inner wall 17 of the microchannel 18.

FIGS. 8 to 11 illustrate subsequent actuation of the polymer actuator elements 10a to 10d of the microfluidic system as illustrated in FIG. 7. This may be used for, for example, moving a fluid through the at least one microchannel 18 of the microfluidic system. By sending a current through floating current wire 14a, a magnetic field is generated which is indicated by field lines 19a in FIG. 8. The current may preferably be between 0.1 A and 10 A, preferably between 0.1 A and 5 A, more preferably between 0.1 A and 1 A. for generating a magnetic field with magnitude sufficient to cause a change in the shape and/or orientation of the actuator elements 10a-d. The magnitude of the magnetic field depends on the current sent through the floating current wires 14a-d and on the radius of the floating current wires 14a-d. The magnitude B of the generated magnetic field can be calculated using the law of Biot and Savart in simplified form:

$$B = \frac{{μ}_{0} I}{r} \qquad ( 2 )$$

wherein μ₀ is the permeability of vacuum, I the current sent through the floating current wires 14a-d and r the radius of the floating current wires 14a-d.

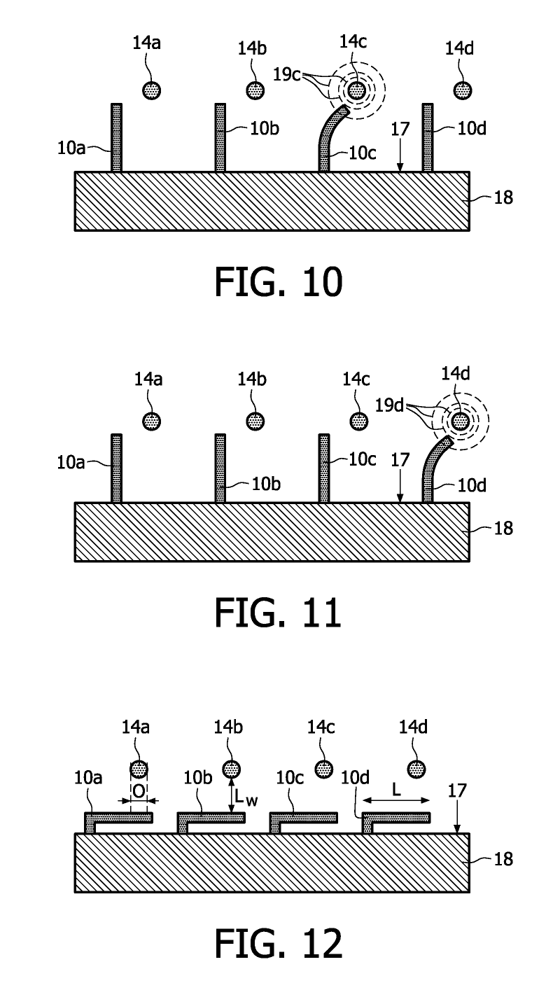

The generated magnetic field actuates the polymer actuator element 10a and causes it to bend or more in general, to change its shape. This is because the polymer actuator element 10a will experience a gradient in magnetic field along its length L. Parts of the polymer actuator element 10a that are further away from the floating current wire 14a will experience a smaller magnetic force than parts of the polymer actuator element 10a that are closer to the floating current wire 14a. This will cause a “curling” motion of the polymer actuator element 10a. Subsequently, a current may be sent through floating current wire 14b hereby generating a magnetic field indicated by field lines 19b in FIG. 9 for actuating polymer actuator element 10b. Then, a current may be sent through floating current wire 14c hereby generating a magnetic field indicated by field lines 19c in FIG. 10 for actuating polymer actuator element 10c. And finally, a current may be sent through floating current wire 14d hereby generating a magnetic field indicated by field lines 19d in FIG. 11 for actuating polymer actuator element 10d. Hence, according to the example given in FIGS. 8 to 11, the polymer actuator elements 10a-d are subsequently actuated.

Hence, the sequential addressing the floating current wires 14a-d results in sequential actuation of the polymer actuator elements 10a-d. By sequential actuation of the polymer actuator elements 10a-d fluid present in the at least one microchannel of the microfluidic system can be pushed through the microchannel. To, for example, obtain local mixing in a microchannel 18 of a microfluidic system, the motion of the actuator elements 10a-d may be deliberately made uncorrelated, i.e. some actuator elements 10a-d may move in one direction whereas other actuator elements 10a-d may move in the opposite direction in an uncorrelated way so as to create local chaotic mixing. Vortices may be created by opposite movements of the actuator elements 10a-d on e.g. opposite positions of the inner walls 17 of the microchannel 18.

It has to be understood that the above discussion is only an example and is not intended to limit the invention in any way. For example, more than one polymer actuator element 10a-d may be actuated at a same time. For example, polymer actuator elements 10a and 10b may first be actuated, followed by polymer actuator elements 10c and 10d. In other words, first a current is sent through floating current wires 14a and 14b and then a current is sent through floating current wires 14c and 14d. Or polymer actuator elements 10a and 10c may first be actuated followed by polymer actuator elements 10b and 10d. In other words, first a current is sent through floating current wires 14a and 14c and then a current is sent through floating current wires 14b and 14d. According to other embodiments, all polymer actuator elements 10a-d may be actuated at a same time or in other words, a current may be sent through all floating current wires 14a-d at a same time. Furthermore, in the example given in FIGS. 7 to 11 the microfluidic system comprises four polymer actuator elements 10a-d and four floating current wires 14a-d. According to other embodiments, the microfluidic system may comprise any other number of polymer actuator elements 10a-d and any number of floating current wires 14a-d. Most preferably, the microfluidic system may comprise a same number of polymer actuator elements 10a-d as the number of floating current wires 14a-d. Moreover, in the example given in FIGS. 7 to 11 when the polymer actuator elements 10a-d are not actuated, they have the shape of a straight flap. However, according to other embodiments of the invention, the initial or non-actuated shape of the polymer actuator elements 10a-d may also be a curled shape. When the polymer actuator elements 10a-d are then actuated, they change their shape by straightening out.

According to still other embodiments of the invention, when the inner wall 17 of the microchannels 18 is lying in a plane, the polymer actuator elements 10a-d may be oriented substantially parallel to the plane of the inner wall 17 of the at least one microchannel 18. This is illustrated in FIGS. 12 to 16. According to this embodiment, the floating current wires 14a-d may be located above the polymer actuator elements 10a-d at a distance L_{w}. According to this embodiment, the distance L_{w} may preferably be such that, when the polymer actuator elements 10a-d are actuated and pulled upwards toward the floating current wires 14a-d, they do not touch the floating current wires 14a-d. Hence, the distance L_{w} may preferably, but not necessarily, be larger than the length L of the polymer actuator elements 10a-d. The distance L_{w} may preferably be between 1 μm and 1000 μm, more preferably between 1 μm and 100 μm and most preferably between 10 μm and 100 μm. Most preferably, the floating current wires 14a-d show an overlap “O” with at least part of the polymer actuator elements 10a-d, the overlap “O” being defined by projection of the floating current wire 14a-d onto the polymer actuator element 10a-d according to a direction substantially perpendicular to the plane of the inner wall 17 of the microchannel 18 (see FIG. 12).

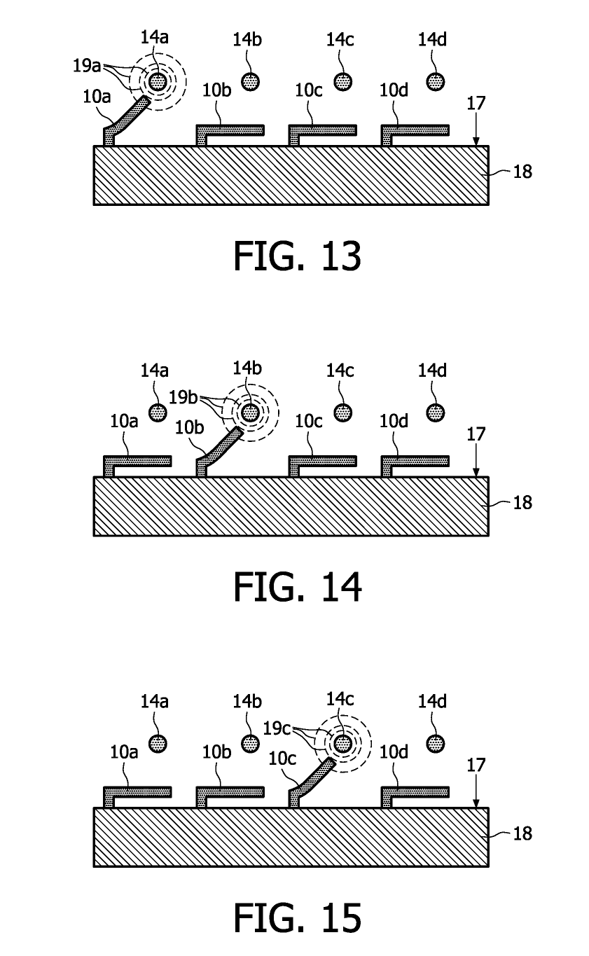

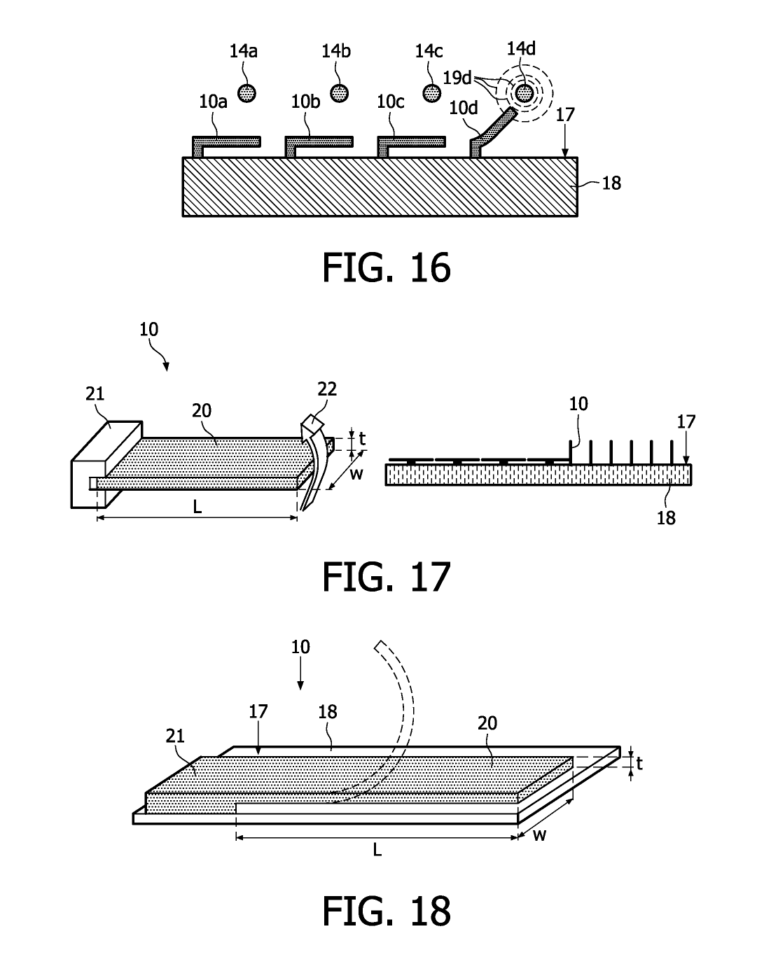

FIGS. 13 to 16 illustrate subsequent actuation of the polymer actuator elements 10a-d in the microfluidic system of FIG. 12. FIG. 13 illustrates actuation of the first polymer actuator element 10a. Therefore, a current of between 0.1 A and 10 A, preferably between 0.1 A and 5 A, more preferably between 0.1 A and 1 A is sent through the first floating current wire 14a hereby generating a magnetic field indicated by magnetic field lines 19a. The magnitude of the generated magnetic field depends on the current I sent through the floating current wires 14a-d and on the radius r of the floating current wires 14a-d and can be calculated using equation (2). The magnetic force generated by the current wire 14a above the polymer actuator element 10a pulls the polymer actuator 10a upward from the inner wall 17 of the microchannel 18 towards the floating current wire 14a. Similarly, FIG. 14, FIG. 15 and FIG. 16 respectively show actuation of the second, third and fourth polymer actuator element 10b, 10c and 10d. Herefore, currents are subsequently sent through the second, third and fourth floating current wire 14b, 14c and 14, hereby generating magnetic fields respectively indicated by magnetic field lines 19b, 19c and 19d.

The sequential addressing the floating current wires 14a-d results in sequential actuation of the polymer actuator elements 10a-d. By sequential actuation of the polymer actuator elements 10a-d fluid present in the at least one microchannel of the microfluidic system can be pushed through the microchannel. To, for example, obtain local mixing in a microchannel 18 of a microfluidic system, the motion of the actuator elements 10a-d may be deliberately made uncorrelated, i.e. some actuator elements 10a-d may move in one direction whereas other actuator elements 10a-d may move in the opposite direction in an uncorrelated way so as to create local chaotic mixing. Vortices may be created by opposite movements of the actuator elements 10a-d on e.g. opposite positions of the inner walls 17 of the microchannel 18.

Again, it has to be understood that this is only an example and is not intended to limit the invention in any way. For example, more than one polymer actuator element 10a-d may be actuated at a same time. For example, polymer actuator elements 10a and 10b may first be actuated, followed by polymer actuator elements 10c and 10d. In other words, first a current is sent through floating current wires 14a and 14b and then a current is sent through floating current wires 14c and 14d. Or polymer actuator elements 10a and 10c may first be actuated followed by polymer actuator elements 10b and 10d. In other words, first a current is sent through floating current wires 14a and 14c and then a current is sent through floating current wires 14b and 14d. According to other embodiments, all polymer actuator elements 10a-d may be actuated at a same time or in other words, a current may be sent through all floating current wires 14a-d at a same time. Furthermore, in the example given in FIGS. 12 to 16 the microfluidic system comprises four polymer actuator elements 10a-d and four floating current wires 14a-d. According to other embodiments, the microfluidic system may comprise any other number of polymer actuator elements 10a-d and any other number of floating current wires 14a-d. Preferably, the microfluidic system may comprise a same number of polymer actuator elements 10a-d as of floating current wires 14a-d. Moreover, in the example given in FIGS. 12 to 16 when the polymer actuator elements 10a-d are not actuated, they have the shape of a straight flap. However, according to other embodiments of the invention, the initial shape of the polymer actuator elements 10a-d, i.e. their shape when they are not actuated, may also be curled upwards. When they are actuated, they change their shape by straightening and thus, according to the present invention, by moving downwards, i.e. moving toward the inner wall 17 of the microchannel 18.

In the above described embodiments, the movement of the actuator elements 10a-d may be measured by, for example, one or more magnetic sensor positioned in the microfluidic system. This may allow to determine flow properties such as, for example, flow speed and/or viscosity of the fluid in the microchannel 18. Furthermore, other fluid details may be measured by using different actuation frequencies. For example, the cell content of the fluid, for example the hematocrit value, or the coagulation properties of the fluid, could be measured in that way.

An advantage of the microfluidic system according to embodiments of the present invention is that, because of the use of magnetic actuation, they may work with very complex biological fluids such as e.g. saliva, sputum or full blood.

A further advantage of the microfluidic system according to embodiments of the present invention is that it provides enhanced actuation effects at equal or lower electrical currents with respect to prior art microfluidic systems in which magnetic actuation is obtained by a magnetic field generated by a current wire located in the wall of the microchannel.

The microfluidic system according to embodiments of the present invention may be used in biotechnological or biomedical applications such as biosensors, rapid DNA separation and sizing, cell manipulation and sorting, or in pharmaceutical applications, in particular high-throughput combinatorial testing where local mixing is essential. The microfluidic system according to embodiments of the present invention may also be used in microchannel cooling systems in microelectronics applications.

For example, the microfluidic system of the present invention may be used in biosensors for, for example, the detection of at least one target molecule, such as proteins, antibodies, nucleic acids (e.g. DNR, RNA), peptides, oligo- or polysaccharides or sugars, in, for example, biological fluids, such as saliva, sputum, blood, blood plasma, interstitial fluid or urine. Therefore, a small sample of the fluid (e.g. a droplet) is supplied to the system, and by manipulation of the fluid within a microchannel system, the fluid is let to the sensing position where the actual detection takes place. By using various sensors in the microfluidic system according to embodiments of the present invention, different types of target molecules may be detected in one analysis run.

Hereinafter, the polymer actuator elements 10a-d which may be used in the microfluidic device according to embodiments of the present invention will be discussed in some more detail.

FIG. 17 and FIG. 18 illustrate an example of a polymer actuator element 10. The left hand part of FIG. 17 represents an actuator element 10 which may respond to an applied magnetic field by bending up and down. The right hand part of FIG. 17 illustrates a cross section in a direction perpendicular to an inner wall 17 of a microchannel 18 which is covered with actuator elements 10. The actuator elements 10 in the right hand part of FIG. 17 may respond to an applied magnetic field by bending from the left to the right.

The polymer actuator element 10 may comprise a polymer Micro-Electro-Mechanical System or polymer MEMS 20 and an attachment means 21 for attaching the polymer MEMS 20 to the inner wall 17 of the microchannel 18 of the microfluidic system. The attachment means 21 can be positioned at a first extremity of the polymer MEMS 20. The polymer MEMS 20 may have the shape of a beam. However, the invention is not limited to beam-shaped MEMS, the polymer actuator element 10 may also comprise polymer MEMS 20 having other suitable shapes, preferably elongate shapes, such as for example the shape of a rod.

An embodiment of how to form a polymer actuator element 10 attached to an inner wall 17 of a microchannel 18 will be described hereinafter.

The polymer actuator elements 10 may be fixed to the inner wall 17 of a microchannel 18 in various possible ways. A first way to fix the polymer actuator elements 10 to the inner wall 17 of a microchannel 18 is by depositing, for example by spinning, evaporation or by another suitable deposition technique, a layer of material out of which the polymer actuator elements 10 will be formed on a sacrificial layer. Therefore, first a sacrificial layer may be deposited on an inner wall 17 of the micro-channel 18. The sacrificial layer may, for example, be composed of a metal (e.g. aluminum), an oxide (e.g. SiOx), a nitride (e.g. SixNy) or a polymer. The material the sacrificial layer is composed of should be such that it can be selectively etched with respect to the material the polymer actuator element 10 is formed of and may be deposited on an inner wall 17 of the microchannel 18 over a suitable length. According to embodiments of the invention the sacrificial layer may, for example, be deposited over the whole surface area of the inner wall 17 of a microchannel 183, typically areas in the order of several cm. However, according to other embodiments, the sacrificial layer may be deposited over a length L, which length L may then be the same length as the length of the actuator element 10a-d, which may typically be between 10 to 100 μm. Depending on the material used, the sacrificial layer may have a thickness of between 0.1 and 10 μm.

In a next step, a layer of polymer material, which later will form the polymer MEMS 20, is deposited over the sacrificial layer and next to one side of the sacrificial layer. Subsequently, the sacrificial layer may be removed by etching the sacrificial layer underneath the polymer MEMS 20. In that way, the polymer layer is released from the inner wall 17 over the length L (as illustrated in FIG. 17), this part forming the polymer MEMS 20. The part of the polymer layer that stays attached to the inner wall 17 forms the attachment means 21 for attaching the polymer MEMS to the microchannel 18, more particularly to the inner wall 17 of the microchannel 18.

Another way to form polymer actuator elements 10a-d which can be used with the present invention may be by using patterned surface energy engineering of the inner wall 17 before applying the polymer material. In that case, the inner wall 17 of the microchannel 18 on which the polymer actuator elements 10a-d will be attached is patterned in such a way that regions with different surface energies are obtained. This can be done with suitable techniques such as, for example, lithography or printing. Therefore, the layer of material out of which the polymer actuator elements 10a-d will be constructed is deposited and structured, each with suitable techniques known by a person skilled in the art. The layer will attach strongly to some areas of the inner wall 17 underneath, further referred to as strong adhesion areas, and weakly to other areas of the inner wall 17, further referred to as weak adhesion areas. It may then be possible to get spontaneous release of the layer at the weak adhesion areas, whereas the layer will remain fixed at the strong adhesion areas. The strong adhesion areas may then form the attachment means 21. In that way it is thus possible to obtain self-forming free-standing polymer actuator elements 10a-d.

The as-processed polymer actuator elements 10a-d need, as already discussed, not to be in a direction substantially parallel to the plane of the inner wall 17 of the microchannel 18, as is suggested in FIGS. 12 to 18 of the present application. The polymer actuator elements 10a-d may also be in a direction substantially perpendicular to the plane of the inner wall 17 of the microchannel 18 as illustrated in FIGS. 7 to 11.

The polymer MEMS 21 may, for example, comprise an acrylate polymer, a poly(ethylene glycol) polymer comprising copolymers, or may comprise any other suitable polymer. Preferably, the polymers the polymer MEMS 21 are formed of should be biocompatible polymers such that they have minimal (bio)chemical interactions with the fluid in the microchannels 18 or the components of the fluid in the microchannels 18. Alternatively, the polymer actuator elements 10a-d may be modified so as to control non-specific adsorption properties and wettability. The polymer MEMS 20 may, for example, comprise a composite material. For example, it may comprise a particle-filled matrix material or a multilayer structure. It could also be mentioned that “liquid crystal polymer network materials” may be used in accordance with the present invention.

In a non-actuated state, i.e. when no magnetic field is applied to the polymer actuator elements 10a-d, the polymer MEMS 20 which, in a specific example, may have the form of a beam, are either curved or straight. A magnetic field applied to the polymer actuator elements 10a-d causes them to bend or straighten out or in other words, causes them to be set in motion. The change in shape of the polymer actuator elements 10a-d sets the surrounding fluid, which is present in the microchannel 18 of the microfluidic system, in motion. In FIG. 17 the bending of the polymer MEMS 20 is indicated by arrow 22 and in FIG. 18 this is illustrated by the dashed line. Due to the fixation to the wall 17 of one extremity of the polymer actuator element 10a-d, the movement obtained resembles that of the movement of the cilia described earlier.

According to the above-described aspect of the invention, the polymer MEMS 20 may have a length L of between 10 and 200 μm and may typically be 100 μm, and may have a width w of between 2 and 30 μm, typically 20 μm. The polymer MEMS 20 may have a thickness t of between 0.1 and 2 μm, typically 1 μm.

The inner walls 17 of the microchannels 18, may be covered with a plurality of straight or curled polymer actuator elements 10a-d. The polymer MEMS 20 can move back and forth, under the action of a magnetic field applied to the actuator elements 10a-d. The actuator elements 10a-d may comprise polymer MEMS 20 which may e.g. have a rod-like shape or a beam-like shape, with their width extending in a direction coming out of the plane of the drawing.

The polymer actuator elements 10a-d at the inner walls 17 of the microchannels 18 may be arranged in one or more rows. For example only, the actuator elements 10a-d may be arranged in two rows of actuator elements 10a-d, i.e. a first row of actuator elements 10a-d on a first position at the inner wall 17 and a second row of actuator elements 10a-d at a second position of the inner wall 17, the first and second position being substantially opposite to each other. According to other embodiments of to the present invention, the actuator elements 10a-d may also be arranged in a plurality of rows of actuator elements 10a-d which may be arranged to form, for example, a two-dimensional array. According to still further embodiments, the actuator elements 10a-d may be randomly positioned at the inner wall 17 of a microchannel 18.

To be able to transport fluid in a certain direction, for example from the left to the right in FIG. 7 or 12, the movement of the polymer actuator elements 10a-d must be asymmetric, as already discussed before. That is, the nature of the “beating” stroke should be different from that of the “recovery” stroke. This may be achieved by a fast beating stroke and a much slower recovery stroke (see FIG. 2).

For a pumping device the motion of the polymer actuator elements 10a-d is provided by a metachronic actuator means. This can be done by providing means for addressing the actuator elements 10a-d either individually or row by row. This may be achieved by providing patterned conductive films that are part of the microchannel wall structure and which may make it possible to create local magnetic fields so that actuator elements 10a-d can be addressed individually or in rows. The same approach may be used for actuator elements 10a-d which are responsive to heat. In that case, the conductive patterns function as local heating elements by resistive heating.

Individual or row-by-row stimulation of the actuator elements 10a-d may thus be possible when the wall 17 of the microchannel 18 comprises a structured pattern through which the applied magnetic field is activated. By proper addressing in time, a co-ordinated stimulation, for example, in a wave-like manner, is made possible. Non-co-ordinated or random actuator means, symplectic metachronic actuator means and antiplectic metachronic actuator means are included within the scope of the present invention (see below).

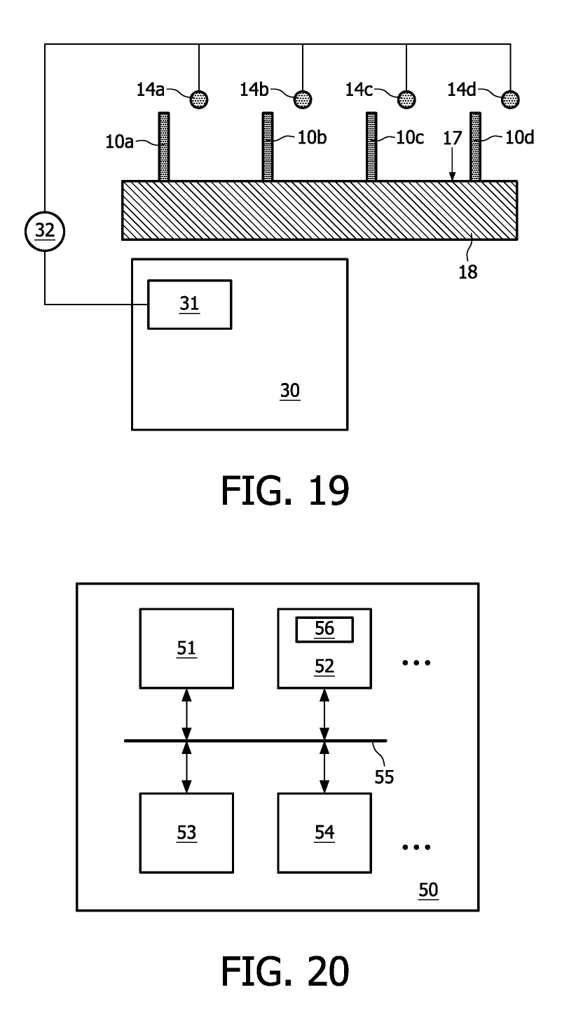

In a further aspect, the present invention also provides a system controller 30 for use in a microfluidic system for controlling a fluid flow through a microchannel of a microfluidic system according to embodiments of the present invention. The system controller 30, which is schematically illustrated in FIG. 19, may control the overall operation of the microfluidic system for controlling a fluid flow through a microchannel 18 of the microfluidic system. The system controller 30 according to the present aspect may comprise a control unit 31 for controlling a magnetic field generator by applying a current through at least one floating current wire 14a-d present in the microchannel 18. The current may for example be applied through a current providing unit 32 such as e.g. a plurality of current or voltage sources. Controlling the magnetic field generator 14a-d may be performed by providing predetermined or calculated control signals to the current providing unit 32. It is clear for a person skilled in the art that the system controller 30 may comprise other control units for controlling other parts of the microfluidic system; however, such other control units are not illustrated in FIG. 19.

The system controller 30 may include a computing device, e.g. microprocessor, for instance it may be a micro-controller. In particular, it may include a programmable controller, for instance a programmable digital logic device such as a Programmable Array Logic (PAL), a Programmable Logic Array, a Programmable Gate Array, especially a Field Programmable Gate Array (FPGA). The use of an FPGA allows subsequent programming of the microfluidic system, e.g. by downloading the required settings of the FPGA. The system controller 30 may be operated in accordance with settable parameters.

The method for controlling a fluid flow through a microchannel 18 of a microfluidic system according to embodiments of the present invention may be implemented in a processing system 50 such as shown in FIG. 20. FIG. 20 shows one configuration of processing system 50 that includes at least one programmable processor 51 coupled to a memory subsystem 52 that includes at least one form of memory, e.g., RAM, ROM, and so forth. It is to be noted that the processor 51 or processors may be a general purpose, or a special purpose processor, and may be for inclusion in a device, e.g., a chip that has other components that perform other functions. Thus, one or more aspects of the present invention can be implemented in digital electronic circuitry, or in computer hardware, firmware, software, or in combinations of them. The processing system may include a storage subsystem 53 that has at least one disk drive and/or CD-ROM drive and/or DVD drive. In some implementations, a display system, a keyboard, and a pointing device may be included as part of a user interface subsystem 54 to provide for a user to manually input information. Ports for inputting and outputting data, e.g. desired or obtained flow rate, also may be included. More elements such as network connections, interfaces to various devices, and so forth, may be included, but are not illustrated in FIG. 20. The various elements of the processing system 50 may be coupled in various ways, including via a bus subsystem 55 shown in FIG. 20 for simplicity as a single bus, but will be understood to those in the art to include a system of at least one bus. The memory of the memory subsystem 52 may at some time hold part or all (in either case shown as 56) of a set of instructions that when executed on the processing system 50 implement the steps of the method embodiments described herein. Thus, while a processing system 50 such as shown in FIG. 20 is prior art, a system that includes the instructions to implement aspects of the methods for manipulating particles or characterizing particles is not prior art, and therefore FIG. 20 is not labeled as prior art.

The present invention also includes a computer program product which provides the functionality of any of the methods according to the present invention when executed on a computing device. Such computer program product can be tangibly embodied in a carrier medium carrying machine-readable code for execution by a programmable processor. The present invention thus relates to a carrier medium carrying a computer program product that, when executed on computing means, provides instructions for executing any of the methods as described above. The term “carrier medium” refers to any medium that participates in providing instructions to a processor for execution. Such a medium may take many forms, including but not limited to, non-volatile media, and transmission media. Non volatile media includes, for example, optical or magnetic disks, such as a storage device which is part of mass storage. Common forms of computer readable media include, a CD-ROM, a DVD, a flexible disk or floppy disk, a tape, a memory chip or cartridge or any other medium from which a computer can read. Various forms of computer readable media may be involved in carrying one or more sequences of one or more instructions to a processor for execution. The computer program product can also be transmitted via a carrier wave in a network, such as a LAN, a WAN or the Internet. Transmission media can take the form of acoustic or light waves, such as those generated during radio wave and infrared data communications. Transmission media include coaxial cables, copper wire and fiber optics, including the wires that comprise a bus within a computer. It is to be understood that although preferred embodiments, specific constructions and configurations, as well as materials, have been discussed herein for devices according to the present invention, various changes or modifications in form and detail may be made without departing from the scope and spirit of this invention.

1. A microfluidic system comprising at least one microchannel (18) having an inner wall (17), the microfluidic system furthermore comprising:
a plurality of ciliary actuator elements (10a-d) attached to the inner wall (17), each ciliary actuator element (10a-d) having a shape and an orientation, and
a magnetic field generator for applying a magnetic field to the plurality of ciliary actuator elements (10a-d) so as to cause a change in their shape and/or orientation,
wherein the magnetic field generator for applying the magnetic field to the plurality of ciliary actuator elements (10a-d) is formed by at least one floating current wire (14a-d) present in the at least one microchannel (18).

2. A microfluidic system according to claim 1, wherein a floating current wire (14a-d) is provided for each of the plurality of ciliary actuator elements (10a-d).

3. A microfluidic system according to claim 1, wherein the at least one floating current wire (14a-d) is attached to the at least one microchannel (18) at one end (15a).

4. A microfluidic system according to claim 1, the inner wall (17) of the at least one microchannel (18) lying in a plane, wherein the plurality of ciliary actuator elements (10a-d) is oriented substantially perpendicular to the plane of the inner wall (17) of the at least one microchannel (18).

5. A microfluidic system according to claim 4, wherein a floating current wire (14a-d) is located in between each two subsequent ciliary actuator elements (10a-d).

6. A microfluidic system according to claim 5, the plurality of ciliary actuator elements (10a-d) having a length L, wherein a distance L_{w} between the wall (17) of the at least one microchannel (18) and the at least one floating current wire (14a-d) is between 0 and 2L.

7. A microfluidic system according to claim 6, wherein the distance L_{w} between the wall (17) of the at least one microchannel (18) and the at least one floating current wire (14a-d) is between L and 1.5L.

8. A microfluidic system according to claim 1, the inner wall (17) of the at least one microchannel (18) lying in a plane, wherein the plurality of ciliary actuator elements (10a-d) are oriented substantially parallel to the plane of the inner wall (17) of the at least one microchannel (18).

9. A microfluidic system according to claim 8, wherein the at least one floating current wire (14a-d) is located above and shows an overlap (O) with at least part of the ciliary actuator elements (10a-d), the overlap (O) being defined by projection of the at least one floating current wire (14a-d) onto the plurality ciliary actuator element (10a-d) according to a direction substantially perpendicular to the plane of the inner wall (17) of the at least one microchannel (18).

10. A microfluidic system according to claim 9, wherein a distance L_{w} between the plurality of ciliary actuator elements (10a-d) and the at least one floating current wire (14a-) is between 10 μm and 100 μm.

11. A microfluidic system according to claim 1, wherein the plurality of ciliary actuator elements (10a-d) are polymer actuator elements.

12. A micro-fluidic system according to claim 11, wherein the polymer actuator elements (10a-d) comprise polymer MEMS.

13. A microfluidic system according to claim 11, wherein the plurality of polymer actuator elements (10a-d) comprises a Inomeric Polymer-Metal Composite (IPMC).

14. A microfluidic system according to claim 1, wherein the ciliary actuator elements (10a-d) comprise one of a uniform continuous magnetic layer (11), a patterned continuous magnetic layer and magnetic particles (12).

15. A microfluidic system according to claim 1, the microfluidic system furthermore comprising at least one magnetic sensor for measuring movement of the plurality of ciliary actuator elements (10a-d).

16. Use of the microfluidic system according to claim 1 in biotechnological, pharmaceutical, electrical or electronic applications.

17. A method for the manufacturing of a microfluidic system comprising at least one microchannel (18), the method comprising:
providing an inner wall (17) of the at least one microchannel (18) with a plurality of ciliary actuator elements (10a-d), and
providing at least one floating current wire (14a-d) in the at least one microchannel for applying a stimulus to said plurality of ciliary actuator elements (10a-d).

18. A method according to claim 17, wherein providing at least one floating current wire (14a-d) in the at least one microchannel (18) is performed by wire bonding at least one current wire (14a-d) to the inner wall (17) of the at least one microchannel (18).

19. A method according to claim 17, furthermore comprising providing the ciliary actuator elements (10a-d) with one of a uniform continuous magnetic layer (11), a patterned continuous magnetic layer, or with magnetic particles (12).

20. A method for controlling a fluid flow through a microchannel (18) of a microfluidic system, the microchannel (18) having an inner wall (17), the inner wall (17) of the microchannel (18) having a plurality of ciliary actuator elements (10a-d), the ciliary actuator elements (10a-d) each having a shape and an orientation; the method comprising:
providing a current through at least one floating current wire (14a-d) present in the microchannel (18) for applying a magnetic field to the ciliary actuator elements (10a-d) so as to cause a change in the shape and/or orientation of at least one ciliary actuator element.

21-26. (canceled)
